(19) United States
(12) Patent Application Publication
(10) Pub. No.: US 2008/0201197 A1
(43) Pub. Date: Aug. 21, 2008

(54) System and Method for Peer Person- And Situation-Based Recommendations

(75) Inventors: Mark Orttung, Menlo Park, CA (US); Aaron Greco, Belmont, CA (US); Tamar Lowell, Oakland, CA (US); Patrick Newman, Palo Alto, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: Rearden Commerce, Inc., San Mateo, CA (US)

(21) Appl. No.: 11/625,145

(22) Filed: Feb. 16, 2007

(51) Int. Cl. G06Q 30/00

(52) U.S. Cl. 705/10

(57) ABSTRACT

A system and method for peer person and/or situation-based recommendations. In one embodiment, the method, which may be implemented on a system, comprises receiving a request for a set of entertainment events, the requesting comprising at least one of an identity of an inviter and an identify of an invitee; selecting a first set of entertainment events from a database by comparing information in the request to one or more units of data in the database, comprising peers of the inviter, peers of the invitee; and, providing to be viewed the first set of entertainment events selected from the database. In an alternative embodiment, the selecting the set of entertainment events from the database, further comprises comparing information in the request to one or more units of data in the database, comprising peer companies of the invitee, peer companies of the inviter.

### BACKGROUND OF THE INVENTION

Business people, and in particular sales people, often must entertain customers or other people with important business relationships. They often have an entertainment budget given to them by their company, but in trying to stay within a budget, they run the risk of using the same events and facilities so frequently as to be counter-productive and a waste of resources. Such people could find it very helpful to compare notes with other people with similar needs and resources, if possible, allowing the business person to discover new events and venues.

What is clearly needed is a system and method that allows a user to find out about new activities done by similar peers—both customer peers and business peers—based on position and standing in a company, company size, available budget, and other such criteria.

### DESCRIPTION OF THE EMBODIMENTS

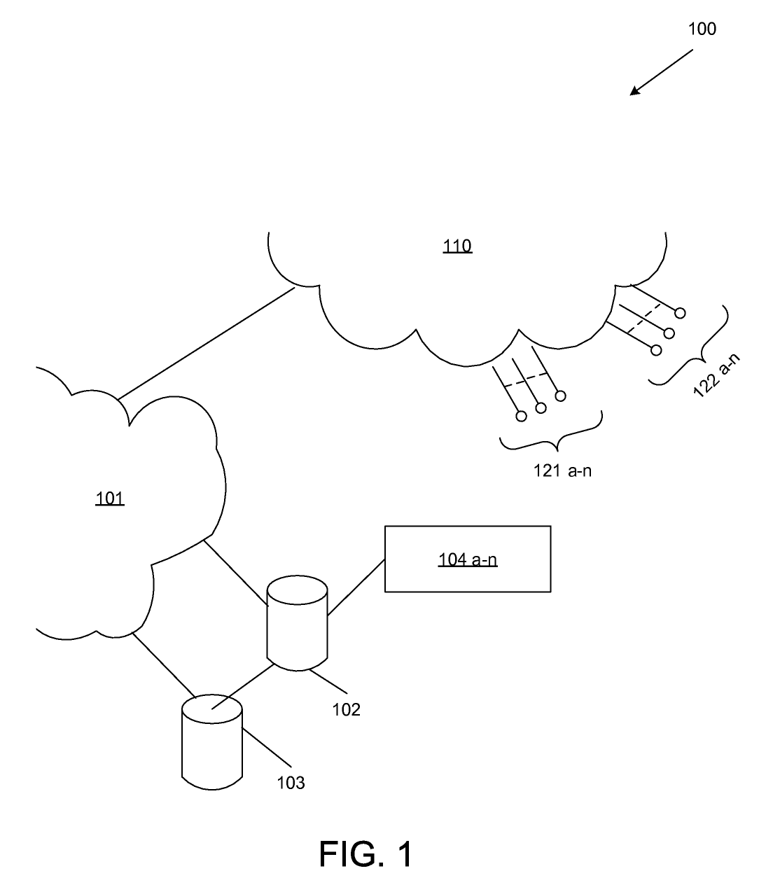

FIG. 1 shows an exemplary overview of a system 100 according to the current invention.

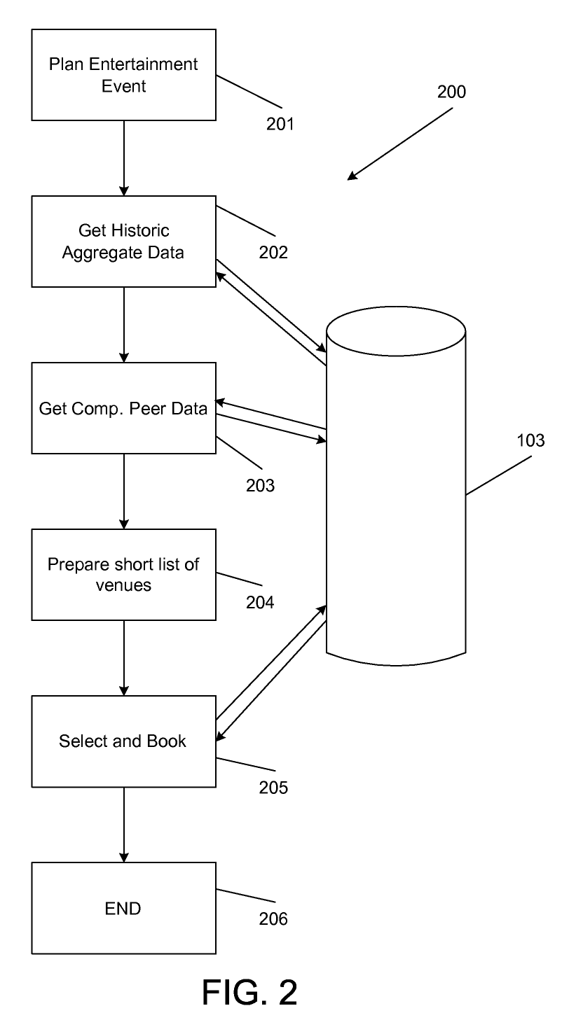

FIG. 2 shows an exemplary process 200 for implementation of the system according to one embodiment of the present invention.

### SUMMARY

A system and method for peer person and/or situation-based recommendations are described here. Some embodiments of the present invention are summarized in this section.

In one embodiment, the method, which may be implemented on a system, comprises receiving a request for a set of entertainment events, the requesting comprising at least one of an identity of an inviter and an identify of an invitee; selecting a first set of entertainment events from a database by comparing information in the request to one or more units of data in the database, comprising peers of the inviter, peers of the invitee; and, providing to be viewed the first set of entertainment events selected from the database. In an alternative embodiment, the selecting the set of entertainment events from the database, further comprises comparing information in the request to one or more units of data in the database, comprising peer companies of the invitee, peer companies of the inviter.

The present disclosure includes methods and apparatuses which perform these methods, including processing systems which perform these methods, and computer readable media which when executed on processing systems cause the systems to perform these methods.

Other features of the present invention will be apparent from the accompanying drawings and from the detailed description which follows.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

FIG. 1 shows an exemplary overview of a system 100 according to the current invention. An electronic services transaction system 65-101 connects to a server 65-102 and a database 65-103. The server hosts several software instances 65-104a-n. System 65-101 connects via Internet 65-110 to system users 65-121a-n and suppliers 65-122a-n. The purpose of system 65-100 is to give guidance to a person whose job often entails inviting one or more other persons to a business entertainment event. The guidance is based on a peer group of the inviter who have similar or comparable factors such as, for example, salary range, position in the company, budget, etc.; invitees who have similar or comparable factors, such as position in their company, salary range (indirectly may be available); and other important similar or comparable factors, such as such as size of the pending deal, etc. All these factors would determine the suitability of the members of a particular peer group. Further, in some cases, data could be gathered from the actions or the feedback of the invitees. For example, the percentage of people in a certain group who accept an invitation to an event of a certain type would be examined, as well as the feedback rating returned by both the invitees and the hosts, to see how they rated specific events. Also, the hosts would be surveyed to see if they were able to meet their business objectives with the event. Based on these and other, similar factors, a recommendation may be generated for venues used for entertainment in similar situations, implying a certain “pre-approval” of expenses, etc.

FIG. 65-2 shows an exemplary process 65-200 for implementation of the system according to one embodiment of the present invention. Such a process 65-200 could be implemented through one of the software instances 65-104a-n. In process 65-201 a user initiates a planning session in the system for an entertainment event. In process 65-202, the system extracts historic aggregation data from database 65-103. In process 65-203 the comparable peer data is received, including data about peers of the inviter, peers of the invitee, peer events, peer companies, expected deal size, position in company of inviter and invitee, weather, season, geographic location, and many other similar factors that may, among others, alone or in any combination, affect budget or allowable type of expenditures. In process 65-204, the system prepares a short list of suggested venues (typically one to five), based on the most suitable matches. In process 65-205, the user then selects and books the preferred event(s). In some cases, if he does not like any of the choices, a More button would bring up the next five choices, and so forth. Only events and venues matching the schedule, company and other applicable guidelines would be shown. In process 65-206, the process ends.

It is clear that many modifications and variations of this embodiment may be made by one skilled in the art without departing from the spirit of the novel art of this disclosure.

The processes described above can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.).

What is claimed is:

1. A method comprising:
receiving a request for a set of entertainment events, the requesting comprising at least one of an identity of an inviter and an identify of an invitee;
selecting a first set of entertainment events from a database by comparing information in the request to one or more units of data in the database, comprising peers of the inviter, peers of the invitee; and
providing to be viewed the first set of entertainment events selected from the database.

2. The method of claim 1, wherein the selecting the set of entertainment events from the database, further comprises comparing information in the request to one or more units of data in the database, comprising peer companies of the invitee, peer companies of the inviter.

3. The method of claim 2, wherein the peers of the inviter comprise individuals having an identified position equivalent to the inviter based on a predetermined criteria, and the peers of the invitee comprise individuals having an identified position equivalent to the invitee based on a predetermined criteria.

4. The method of claim 1, wherein the selecting the set of entertainment events from the database, further comprises comparing information in the request to one or more units of data in the database, comprising an identified quantification of a prospective transaction related to the invitee and inviter.

5. The method of claim 3, wherein the selecting the set of entertainment events from the database, further comprises selecting the events in accordance with predetermined policies related to one of the inviter or a company of the inviter.

6. The method of claim 5, wherein the predetermined policies related to one of the inviter or a company of the inviter, comprise budget parameters for entertainment events.

7. The method of claim 6, wherein the providing to be viewed the set of entertainment events selected from the database, further comprises providing an option to have a second set of entertainment events provided, the separate set selected from the database by the comparing of information in the request to one or more units of data in the database.

8. The method of claim 7, wherein the first set of events provided are a greater match, relative to the second set of events, between information provided in the request and the data units in the database based on predetermined criteria.

9. The method of claim 8, further comprising:
Receiving a selection of an event and booking the event.

10. A machine readable medium having stored thereon a set of instructions which when executed, cause a machine to perform a method comprising:
receiving a request for a set of entertainment events, the requesting comprising at least one of an identity of an inviter and an identify of an invitee;
selecting a first set of entertainment events from a database by comparing information in the request to one or more units of data in the database, comprising peers of the inviter, peers of the invitee; and
providing to be viewed the first set of entertainment events selected from the database.

11. The machine readable medium of claim 10, wherein the selecting the set of entertainment events from the database, further comprises comparing information in the request to one or more units of data in the database, comprising peer companies of the invitee, peer companies of the inviter.

12. The machine readable medium of claim 11, wherein the peers of the inviter comprise individuals having an identified position equivalent to the inviter based on a predetermined criteria, and the peers of the invitee comprise individuals having an identified position equivalent to the invitee based on a predetermined criteria.

13. The machine readable medium of claim 10, wherein the selecting the set of entertainment events from the database, further comprises comparing information in the request to one or more units of data in the database, comprising an identified quantification of a prospective transaction related to the invitee and inviter.

14. The machine readable medium of claim 12, wherein the selecting the set of entertainment events from the database, further comprises selecting the events in accordance with predetermined policies related to one of the inviter or a company of the inviter.

15. The machine readable medium of claim 14, wherein the predetermined policies related to one of the inviter or a company of the inviter, comprise budget parameters for entertainment events.

16. The machine readable medium of claim 15, wherein the providing to be viewed the set of entertainment events selected from the database, further comprises providing an option to have a second set of entertainment events provided, the separate set selected from the database by the comparing of information in the request to one or more units of data in the database.

17. The machine readable medium of claim 16, wherein the first set of events provided are a greater match, relative to the second set of events, between information provided in the request and the data units in the database based on predetermined criteria.

18. The machine readable medium of claim 17, further comprising:
Receiving a selection of an event and booking the event.

19. A system comprising:
a means for receiving a request for a set of entertainment events, the requesting comprising at least one of an identity of an inviter and an identify of an invitee;
a means for selecting a first set of entertainment events from a database by comparing information in the request to one or more units of data in the database, comprising peers of the inviter, peers of the invitee; and
a means for providing to be viewed the first set of entertainment events selected from the database.

20. The system of claim 19, wherein the means for selecting the set of entertainment events from the database, further comprises means for comparing information in the request to one or more units of data in the database, comprising peer companies of the invitee, peer companies of the inviter.
